(19) United States
(12) Patent Application Publication
(10) Pub. No.: US 2015/0269587 A1
(43) Pub. Date: Sep. 24, 2015

(54) METHODS FOR PREDICTING CUSTOMER SATISFACTION AND DEVICES THEREOF

(71) Applicant: Wipro Limited, Bangalore (IN)

(72) Inventors: Radhakrishnan Swaminathan, Jupiter, FL (US); Venkatakrishnan Rajaram, Bangalore (IN); Hemalatha Seetharamaiah, Bangalore (IN)

(73) Assignee: Wipro Limited, Bangalore (IN)

(21) Appl. No.: 14/267,382

(22) Filed: May 1, 2014

(30) Foreign Application Priority Data
Mar. 19, 2014 (IN) 1453/CHE/2014

(51) Int. Cl. G06Q 30/00

(52) U.S. Cl. CPC G06Q 30/016; G06Q 50/06

(57) ABSTRACT

A method, non-transitory computer readable medium and utility management computing device for obtaining data associated with one or more electric utilities from a utility monitoring system. An asset reliability score and a consumption score is determined from the obtained data associated with the one or more electric utilities. Next, a customer satisfaction score is determined for the one or more electric utilities based on the determined asset reliability score and the consumption score. The determined customer satisfaction score for the one or more electric utilities is provided.

This application claims the benefit of Indian Patent Application Filing Number 1453/CHE/2014, filed on Mar. 19, 2014, which is hereby incorporated by reference in its entirety.

### FIELD

This technology relates to methods for predicting of customer satisfaction and devices thereof.

### BACKGROUND

Regulations now require many electric utilities to measure and publish reports on the level of customer satisfaction. These reports on the level of customer satisfaction are a factor for electric utilities to try and address areas of concern and for market investors when evaluating these electric utilities. As a result, it is becoming more imperative for these electric utilities to accurately monitor and maintain a high level of customer satisfaction.

Currently, technologies for determining the level of customer satisfaction typically do so by recording and measuring customer perception via surveys. By way of example only, these surveys may be manually taken by customers of the electric utilities or other enterprises being evaluated and then the answers are collated to arrive at a determined level of customer satisfaction.

Unfortunately, these existing technologies often do not provide an accurate determination of the level of customer satisfaction because the questions and resulting answers are generic. Additionally, the resulting answers do not capture specific context or information associated with each customer as the metrics used for measuring are utility wide indicators. Without an accurate determination, the results of these surveys can not provide an accurate assessment of the level of customer satisfaction or any insight on appropriate corrective action which might be required.

Further, these existing technologies often are very slow to obtain and provide a determination of the level of customer satisfaction. As a result, even if the determination of the level of customer satisfaction is accurate, there is a delayed response for any corrective action.

### SUMMARY

A method for predicting customer satisfaction includes obtaining by a utility management computing device data associated with one or more electric utilities from a utility monitoring system. An asset reliability score and a consumption score is determined from the obtained data associated with the one or more electric utilities by the utility management computing device. Next, a customer satisfaction score is determined for the one or more electric utilities based on the determined asset reliability score and the consumption score by the utility management computing device. The determined customer satisfaction score for the one or more electric utilities is provided by the utility management computing device.

A utility management computing device comprising a memory coupled to one or more processors which are configured to execute programmed instructions stored in the memory includes obtaining data associated with one or more electric utilities from a utility monitoring system. An asset reliability score and a consumption score is determined from the obtained data associated with the one or more electric utilities. Next, a customer satisfaction score is determined for the one or more electric utilities based on the determined asset reliability score and the consumption score. The determined customer satisfaction score for the one or more electric utilities is provided.

A non-transitory computer readable medium having stored thereon instructions for predicting customer satisfaction comprising machine executable code which when executed by at least one processor, causes the processor to perform steps including obtaining data associated with one or more electric utilities from a utility monitoring system. An asset reliability score and a consumption score is determined from the obtained data associated with the one or more electric utilities. Next, a customer satisfaction score is determined for the one or more electric utilities based on the determined asset reliability score and the consumption score. The determined customer satisfaction score for the one or more electric utilities is provided.

This technology provides a number of advantages including providing more effective methods, devices, and non-transitory computer readable medium for predicting customer satisfaction. In this example, the customer satisfaction is predicted without receiving any feedback from the customer.

By way of example only, when a customer contacts a customer service center, the service representative who would be answering the call will in advance know the customer satisfaction level. Using this customer satisfaction level, the service representative can effectively assist the customer. Accordingly, if prior to answering the call the service representative knows that the customer satisfaction level is very low, the call could be routed to a more experienced customer service representative or to a senior manager to manage the service call. Further, when the when the customer satisfaction level is very low, the technology disclosed herein can verify in relation to the demography of the customer's residence to determine an exact reasons for the issues thereby resulting in knowing in advance the reasons for the low satisfaction level of the customer. Furthermore, when the call is routed to a senior manager to handle the customer is with very low customer satisfaction level, the utility management computing device also provides the senior manager a nuance and context specific information prior to handling the call with the customer. By way of example only, these nuance and context specific information can include an insight on systemic level issues that can be proactively addressed based on the customer satisfaction level. For purpose of further illustrated, when there exist a higher level asset issue such as at a feeder level which might be causing the customer frequent power interruptions, the technology disclosed herein provides the information to the senior manager indicating that there are other customers within the same demography experiencing similar kind of frequent interruptions. Accordingly, this technique would there result in providing higher quality of service to the customer. Additionally, the service representative will in advance know the suggestion or suggestions that could be provided to the customer which in turn will increase the customer satisfaction level. On the contrary, if prior to answering the call the service representative knows that the customer is extremely satisfied, then the call could be routed to a new service representative to manage the service call.

### BRIEF DESCRIPTION OF THE DRAWINGS

FIG. 1 is an exemplary network environment comprising a utility management computing device for predicting of customer satisfaction;

FIG. 2 is an exemplary functional block diagram of the utility management computing device; and

FIG. 3 is an exemplary functional block diagram of the modules within a memory of the utility management computing device;

FIG. 4 is an exemplary flowchart for a method for predicting customer satisfaction;

FIG. 5 is an exemplary flowchart illustrating a method for determining a asset reliability score;

FIG. 6 is an exemplary frequency percentile to frequency quartile conversion table;

FIG. 7 is an exemplary duration percentile to duration quartile conversion table;

FIG. 8 is an exemplary asset reliability score table;

FIG. 9 is an exemplary flowchart illustrating a method for determining a consumption score;

FIG. 10 is an exemplary flowchart illustrating a method for assessing power regression;

FIG. 11 is an exemplary monthly power consumption score table;

FIG. 12 is an exemplary customer satisfaction score table; and

FIGS. 13-14 are exemplary graphs providing a visual representation of the customer satisfactions score.

### DETAILED DESCRIPTION

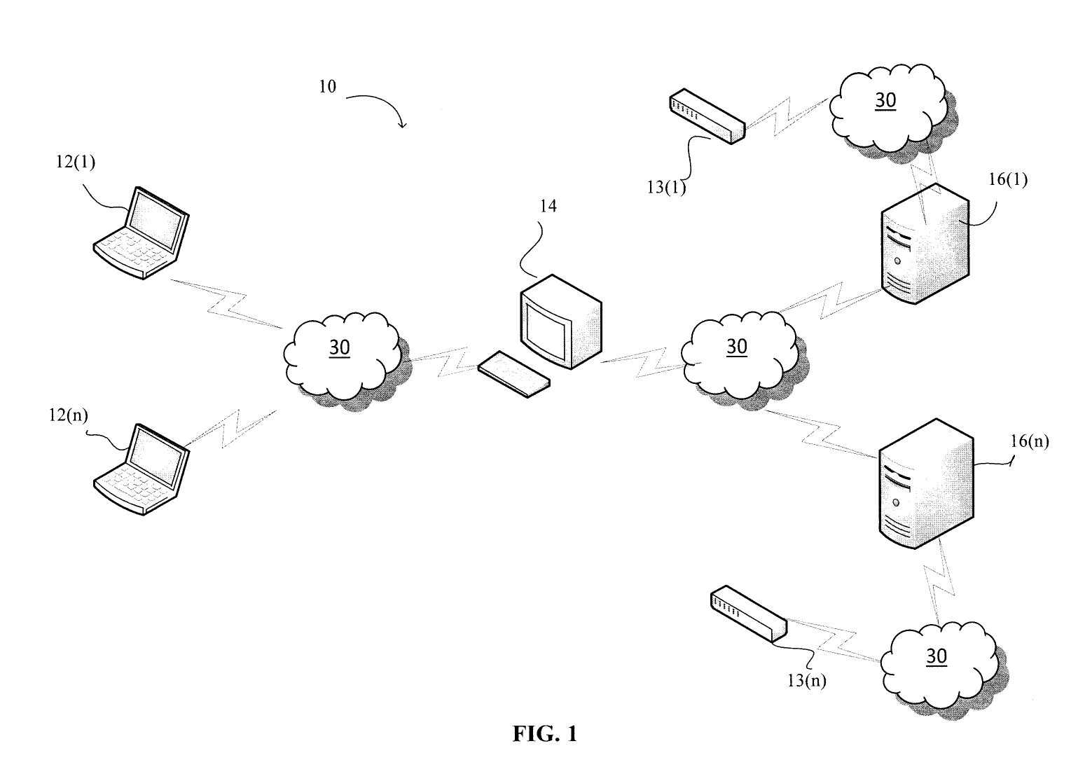

An exemplary network environment 10 with a utility management computing device 14 for predicting customer satisfaction is as illustrated in FIG. 1. The exemplary network environment 10 includes a plurality of customer service computing devices 12(1)-12(n), the utility management computing device 14, one or more utilities 13(1)-13(n), and a plurality of utility monitoring systems 16(1)-16(n) which are coupled together by the communication networks 30, although the environment can include other types and numbers of devices, components, elements and communication networks in a variety of other topologies and deployments. While not shown, the exemplary environment 10 may include additional components, such as routers, switches and other devices which are well known to those of ordinary skill in the art and thus will not be described here. This technology provides a number of advantages including providing more effective methods, non-transitory computer readable medium and devices for predicting customer satisfaction.

Referring more specifically to FIG. 1, utility management computing device 14 interacts with the plurality of customer service computing devices 12(1)-12(n), one or more utilities 13(1)-13(n), and plurality of utility monitoring systems 16(1)-16(n) through the communication networks 30, although the utility management computing device 14 can interact with the customer service computing devices 12(1)-12(n), one or more utilities 13(1)-13(n) and the plurality of utility monitoring systems 16(1)-16(n) using other methods or techniques. Communication networks 30 include local area networks (LAN), wide area network (WAN), 3G technologies, GPRS or EDGE technologies, although the communication networks 30 can include other types and numbers of networks and other network topologies.

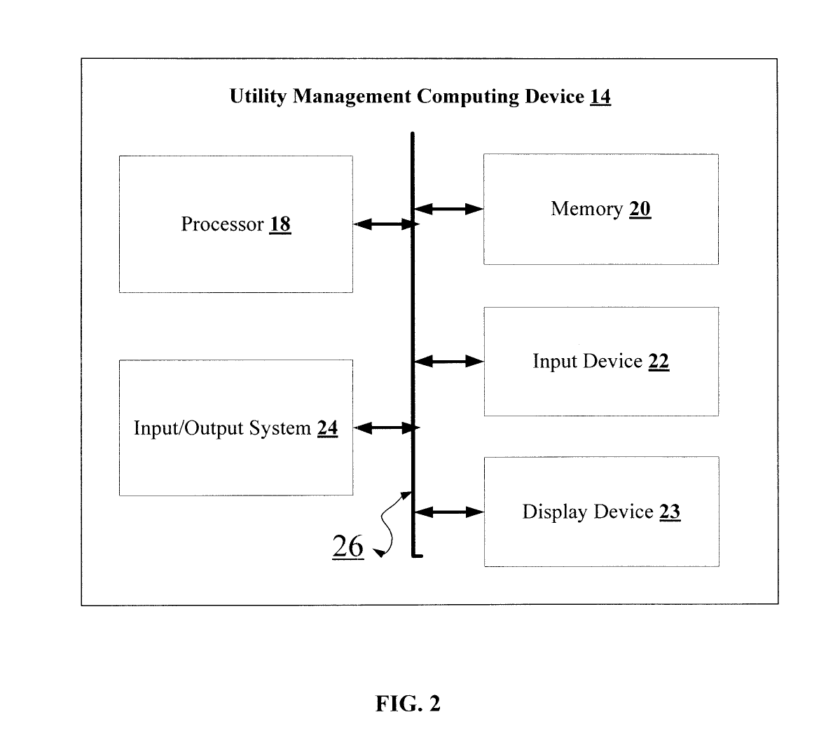

The utility management computing device 14 predicts customer satisfaction within a network environment 10 as illustrated and described with the examples herein, although utility management computing device 14 may perform other types and numbers of functions and in other types of networks. As illustrated in FIG. 2, the utility management computing device 14 includes at least one processor 18, memory 20, input device 22 and display device 23, and input/output (I/O) system 24 which are coupled together by bus 26, although utility management computing device 14 may comprise other types and numbers of elements in other configurations.

Processor(s) 18 may execute one or more computer-executable instructions stored in the memory 20 for the methods illustrated and described with reference to the examples herein, although the processor(s) can execute other types and numbers of instructions and perform other types and numbers of operations. The processor(s) 18 may comprise one or more central processing units (“CPUs”) or general purpose processors with one or more processing cores, such as AMD® processor(s), although other types of processor(s) could be used (e.g., Intel®).

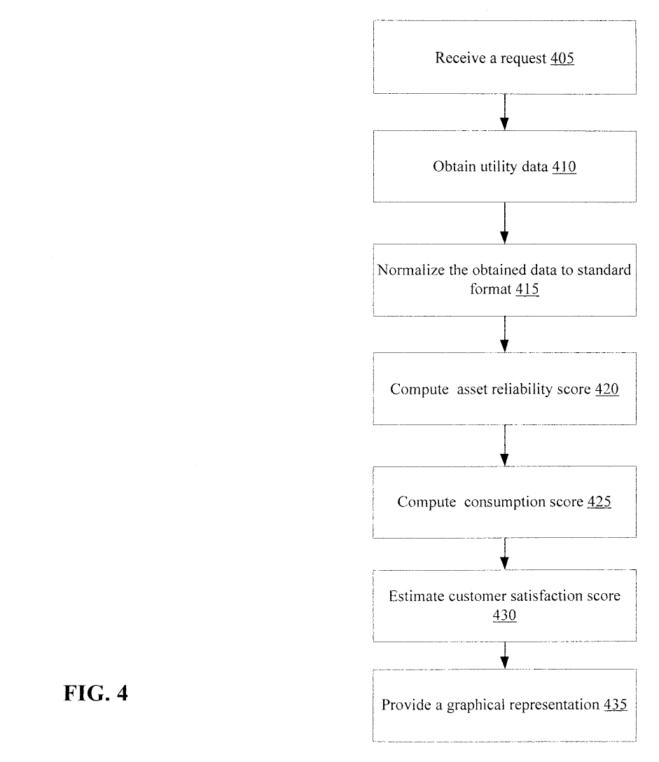

Memory 20 may comprise one or more tangible storage media, such as RAM, ROM, flash memory, CD-ROM, floppy disk, hard disk drive(s), solid state memory, DVD, or any other memory storage types or devices, including combinations thereof, which are known to those of ordinary skill in the art. Memory 20 may store one or more programmed instructions of this technology as illustrated and described with reference to the examples herein that may be executed by the one or more processor(s) 18. By way of example only, the flow charts shown in FIGS. 4, 5, 9 and 10 are representative of programmed steps or actions of this technology that may be embodied or expressed as one or more non-transitory computer or machine readable having stored instructions stored in memory 20 that may be executed by the processor(s) 18, although other types and numbers of programmed instructions and/or other data may be stored.

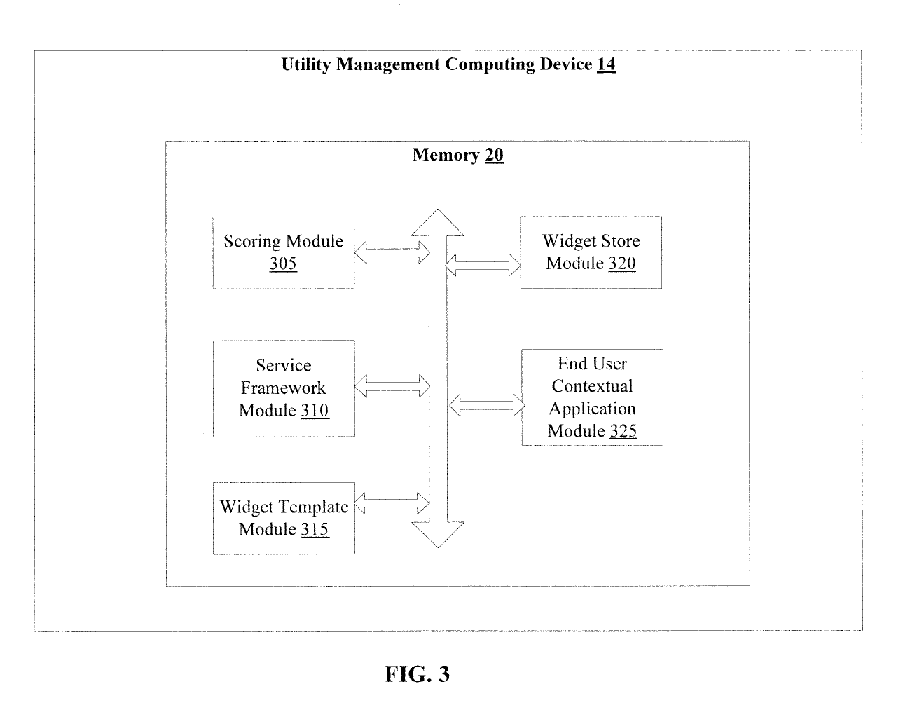

Additionally as illustrated in FIG. 3, the memory 20 includes a scoring module 305, a service framework module 310, widget templates module 315, widget store module 320 and end user contextual application module 325 to assist the utility management computing device 14 with predicting customer satisfaction, although memory 20 can include other types and numbers of modules. In this example, the scoring module 305 includes a set of methods to calculate the scores for service reliability, high bill estimates and customer satisfaction, although the can include other types or amounts of information. The service framework module 310 is an architecture layer that provides services to the other widgets and application layers to enable them to query and access scores and information for the customer from the plurality of utility management systems 13(1)-13(n), although the service framework module 310 can include other types or amounts of information. The widget template module 315 in this example is a set of configuration information to enable development of widgets required for creating the customer profiles as per enterprise widget design requirements, although the widget template module 315 can include other types or amounts of information to assist the utility management computing device 14 to predict customer satisfaction. The widget store module 320 includes implementations on specific aspects of the customer profile and details pertaining to the customer satisfaction score. Additionally, the widget store module 320 will also be accessed by other modules within the memory 20 to create user specific customer views. The end user contextual applications module 325 includes task specific applications developed for customer care professionals and field crew. These applications can be accessed from web portals and/or mobile devices as per requirements.

Input device 22 enables a user, such as an administrator, to interact with the utility management computing device 14, such as to input and/or view data and/or to configure, program and/or operate it by way of example only. By way of example only, input device 22 may include one or more of a touch screen, keyboard and/or a computer mouse.

The display device 23 enables a user, such as an administrator, to interact with the utility management computing device 14, such as to view and/or input information and/or to configure, program and/or operate it by way of example only. By way of example only, the display device 23 may include one or more of a CRT, LED monitor, LCD monitor, or touch screen display technology although other types and numbers of display devices could be used.

The I/O system 24 in the utility management computing device 14 is used to operatively couple and communicate between the utility management computing device 14, the customer service computing devices 12(1)-12(n), one or more utilities 13(1)-13(n) and plurality of utility monitoring systems 16(1)-16(n) and which are all coupled together by communication network 30. In this example, the bus 26 is a hyper-transport bus in this example, although other bus types and links may be used, such as PCI.

Each of the plurality of customer service computing devices 12(1)-12(n) includes a central processing unit (CPU) or processor, a memory, an interface device, and an I/O system, which are coupled together by a bus or other link, although other numbers and types of network devices could be used. The plurality of customer service computing devices 12(1)-12(n) communicate with the utility management computing device 14 for requesting prediction of customer satisfaction of one or more utilities 13(1)-13(n) through the plurality of utility monitoring systems 16(1)-16(n), although the customer service computing devices 12(1)-12(n) can interact with the utility management computing device 14 by other techniques. The plurality of customer service computing devices 12(1)-12(n) may run interface application(s), such as a Web browser, that may provide an interface to make requests for and receive content and/or communicate with web applications stored on the plurality of servers 16(1)-16(n) via the communication network 30.

The network environment 10 also includes the plurality of utility monitoring systems 16(1)-16(n). Each of the plurality of utility monitoring systems 16(1)-16(n) includes a central processing unit (CPU) or processor, a memory, an interface device, and an I/O system, which are coupled together by a bus or other link, although other numbers and types of network devices could be used. The plurality of utility monitoring systems 16(1)-16(n) communicate with the utility management computing device 14 through communication network 30, although the utility monitoring systems 16(1)-16(n) can interact with the utility management computing device 14 by other techniques. Various network processing applications, such as CIFS applications, NFS applications, HTTP Web Server applications, and/or FTP applications, may be operating on the plurality of utility monitoring systems 16(1)-16(n) and transmitting content (e.g., files, Web pages) to the plurality of customer service computing devices 12(1)-12(n) or the utility management computing device 14 in response to the requests. In this example, each of the plurality of utility monitoring systems 16(1)-16(n) obtains data associated with the one or more utilities 13(1)-13(n) at frequent intervals of time. By way of example only, each utility of the one or more utilities 13(1)-13(n) can have an associated utility monitoring system 16(1)-16(n), although each utility can have multiple utility monitoring systems.

Additionally in this example, the one or more utilities 13(1)-13(n) is an electric power utility that engages in the generation, transmission and distribution of electricity for sale generally in a regulated market, although the one or more utilities 13(1)-13(n) can perform other types or amounts of functions. Each of the one or more utilities 13(1)-13(n) includes a central processing unit (CPU) or processor, a memory, an interface device, and an I/O system, which are coupled together by a bus or other link, although other numbers and types of network devices could be used. The one or more utilities 13(1)-13(n) communicate with the plurality of utility monitoring systems 16(1)-16(n) via communication network 30, although the one or more utilities 13(1)-13(n) can interact with the plurality of utility monitoring systems 16(1)-16(n) by other techniques.

Although an exemplary telecommunications network environment 10 with the plurality of customer service computing devices 12(1)-12(n), one or more utilities 13(1)-13(n), utility management computing device 14 and plurality of utility monitoring systems 16(1)-16(n) are described and illustrated herein, other types and numbers of systems, devices in other topologies can be used. It is to be understood that the systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

An exemplary method for predicting customer satisfaction will now be described with reference to FIGS. 1-14. Particularly with reference to FIG. 4, in step 405, the utility management computing device 14 receives a request to predict customer satisfaction for a customer from one of the plurality of customer service computing devices 12(1)-12(n), although the utility management computing device 14 can receive other types or amounts of requests from other devices. By way of example only, the utility management computing device 14 receives the customer name and a unique customer number associated with the customer name for which a customer satisfaction is required to be predicted, although the received request can include other types or amounts of information.

Responsive to the request, in step 410, the utility management computing device 14 obtains utility data of the customer from one of the plurality of customer service computing devices 12(1)-12(n) associated with one or more utilities 13(1)-13(n) from a corresponding one of the plurality of utility management systems 16(1)-16(n) using the customer name and customer number, although the utility management computing device 14 can obtain the utility data from other locations, such as transformers or meters, using other parameters and in other manners. By way of example only, the utility data includes power outage data, demographic information of the customer, billing details of the customer and/or power consumption data, although utility data can include other types or amounts of information.

In step 415, the utility management computing device 14 normalizes the obtained data into a standard format. In this example, normalizing relates to converting the obtained data from a native format to a standard format by converting the values to a metric system or accurately retaining the decimal places, although the obtained data can be processed in other manners.

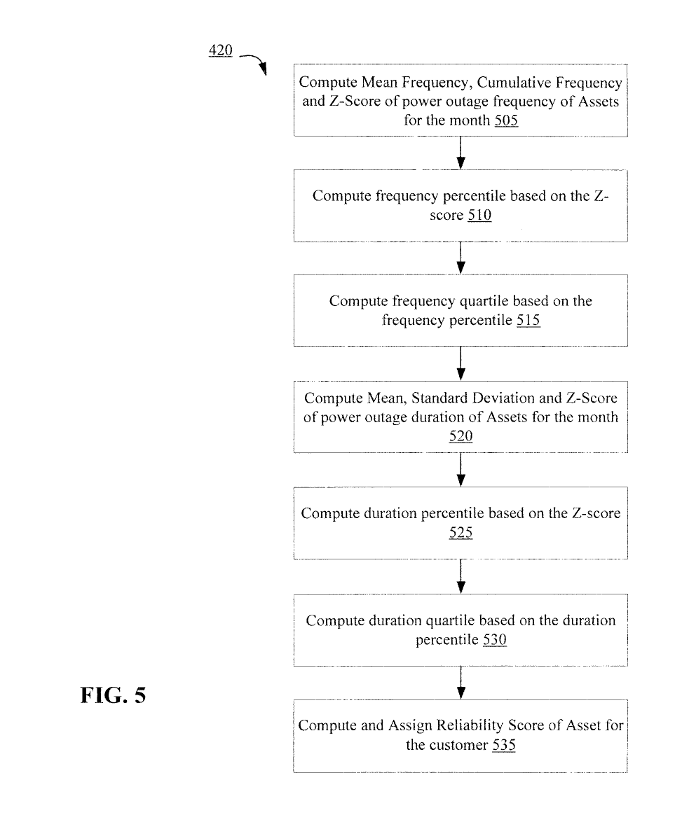

In step 420, the utility management computing device 14 determines a asset score using the obtained utility data associated with the customer from the one of the plurality of customer service computing devices 12(1)-12(n) in the normalized format. In this example, the utility management computing device 14 determines a monthly asset score, although the utility management computing device 14 can determine a quarterly, half yearly or yearly asset score. An example of determining the asset score will now be described with reference to FIG. 5, although other approaches for determining the asset score can be used.

In step 505, the utility management computing device 14 computes a mean frequency, a cumulative frequency and a Z-score for the frequency of the power outage associated with the one of the plurality of utilities 13(1)-13(n) associated with the customer from the normalized data. In this example, the cumulative frequency is computed by adding the frequency of power outage over a period of time such as past twelve months, although the cumulative frequency can be computed using other techniques. Next, the utility management computing device 14 computes the mean frequency for the frequency of power outage by dividing the cumulative frequency by the total number of data points such as total number of months, although the utility management computing device can computer the mean frequency using other techniques. Further, the utility management computing device 14 computes the Z-score (average power outage value) based on the computed cumulative frequency and mean frequency using the formula Z=(data points+mean frequency)/cumulative frequency, although the utility management computing device 14 can compute the Z score using other techniques.

In step 510, the utility management computing device 14 computes a frequency percentile of the power outage based on the Z score computed in the previous step. In this example, the utility management computing device 14 compares the Z-score against a table including corresponding frequency percentile to determine the frequency percentile of the power outage, although the utility management computing device 14 can use other techniques to determine the frequency percentile.

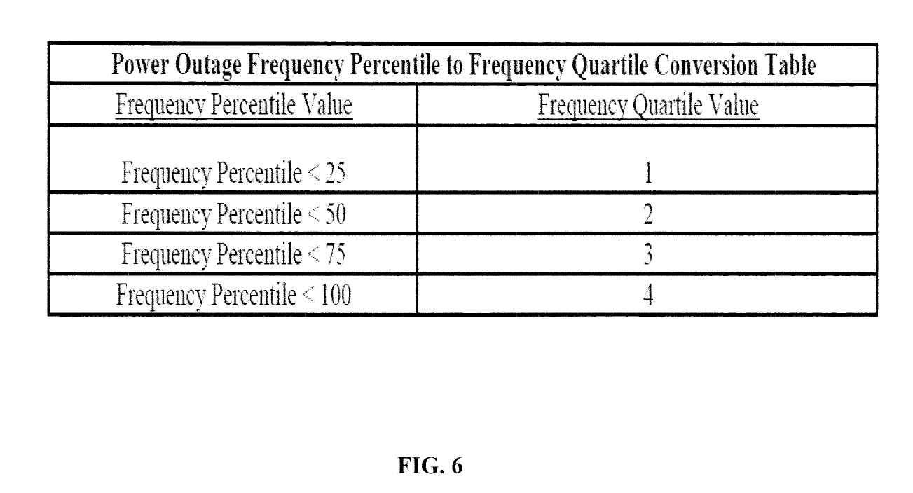

In step 515, the utility management computing device 14 computes a frequency quartile of the power outage based on the frequency percentile computed in the previous step. In this example, the utility management computing device 14 refers to a frequency percentile to frequency quartile conversion table illustrated in FIG. 6 to compute the frequency quartile of the power outage, although the utility management computing device 14 can use other techniques to compute the frequency percentile. As illustrated in FIG. 6, by way of example only, each range of the frequency percentile has a corresponding frequency quartile value.

In step 520, the utility management computing device 14 computes a mean duration, a cumulative duration and a Z-score for the duration of the power outage associated with one of the plurality of utilities 13(1)-13(n) associated with the customer from the normalized data. In this example, the utility management computing device 14 utilizes the technique illustrated in step 505 to compute the mean duration, a cumulative duration and a Z-score for the duration of the power, although the utility management computing device 14 can use other techniques to compute.

In step 525, the utility management computing device 14 computes the duration percentile using the technique illustrated in step 510, although the utility management computing device 14 can use other techniques.

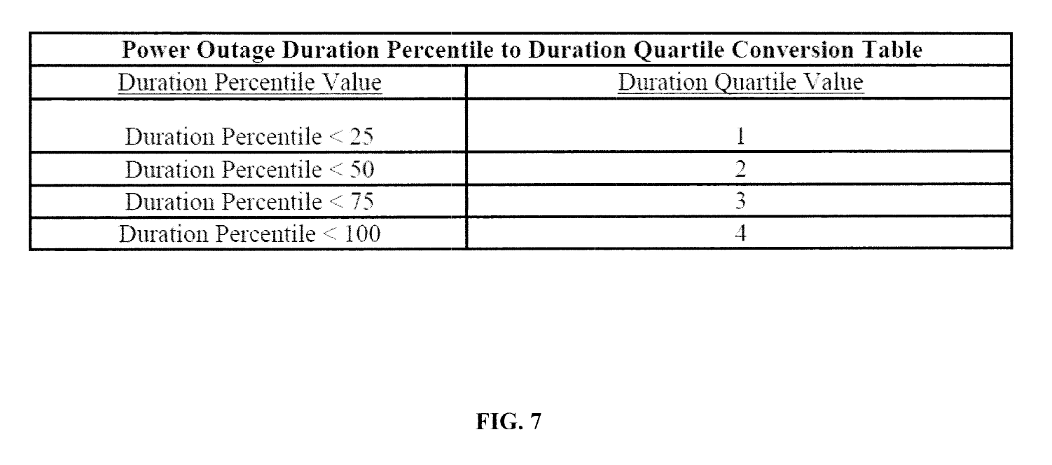

In step 530, the utility management computing device 14 computes the duration quartile from the duration percentile using a conversion table illustrated in FIG. 7, although the utility management computing device 14 can compute the duration quartile using other techniques. As illustrated in FIG. 7, each range of the duration percentile has a corresponding duration quartile value.

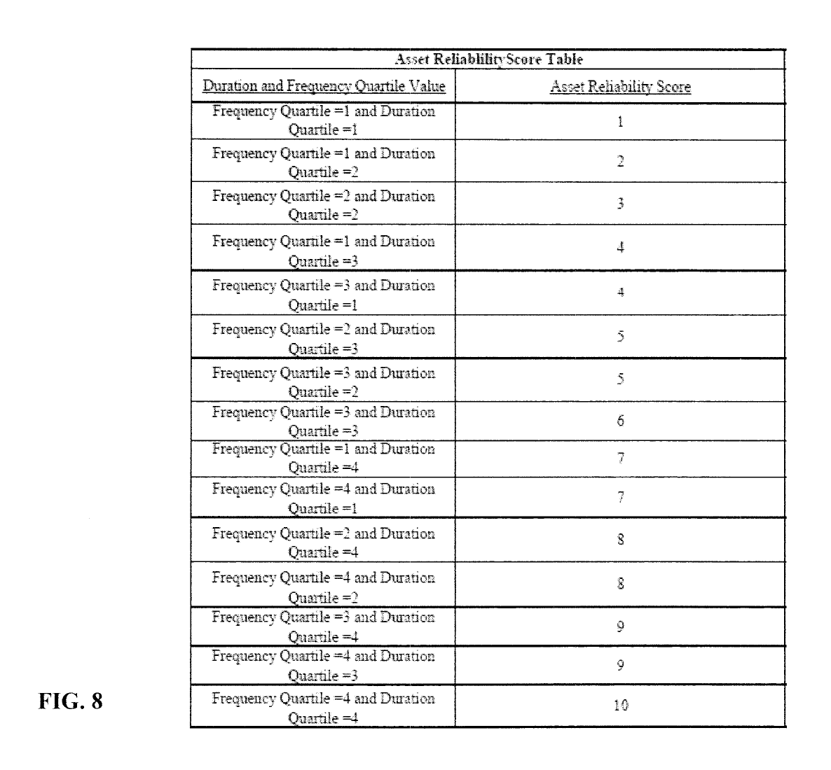

In step 535, the utility management computing device 14 determines and assigns the asset reliability score for the customer using the computed frequency quartile and the duration quartile, although the utility management computing device 14 can use other techniques to determine the asset reliability score. In this example, the utility management computing device 14 refers to a table which includes frequency quartile and the duration quartile along with the corresponding asset reliability score as illustrated in FIG. 8. As illustrated in the exemplary table of FIG. 8, each combination of frequency quartile and duration quartile includes a corresponding asset reliability score.

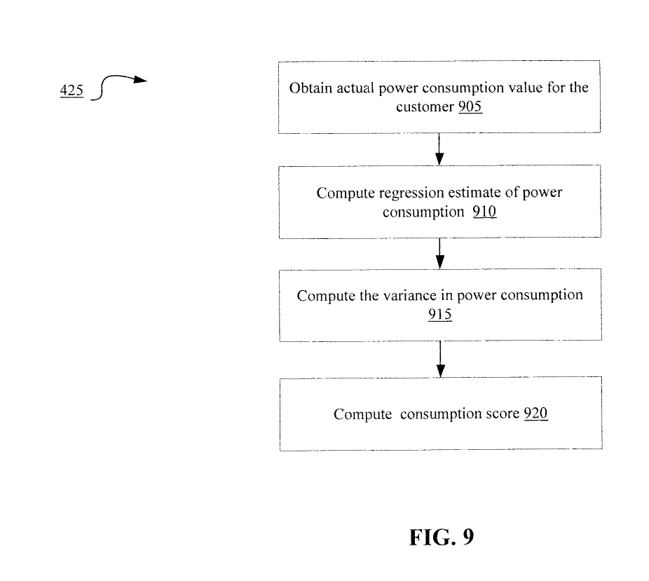

Now with reference back to FIG. 4, in step 425 the utility management computing device 14 determines a consumption score which will now be illustrated with reference to the flowchart in FIG. 9.

In step 905, the utility management computing device 14 identifies the actual power consumption value for the customer from the utility data obtained in step 410, although the utility management computing device 14 can obtain and identify the actual power consumption value from one of the plurality of utility management systems 16(1)-16(n).

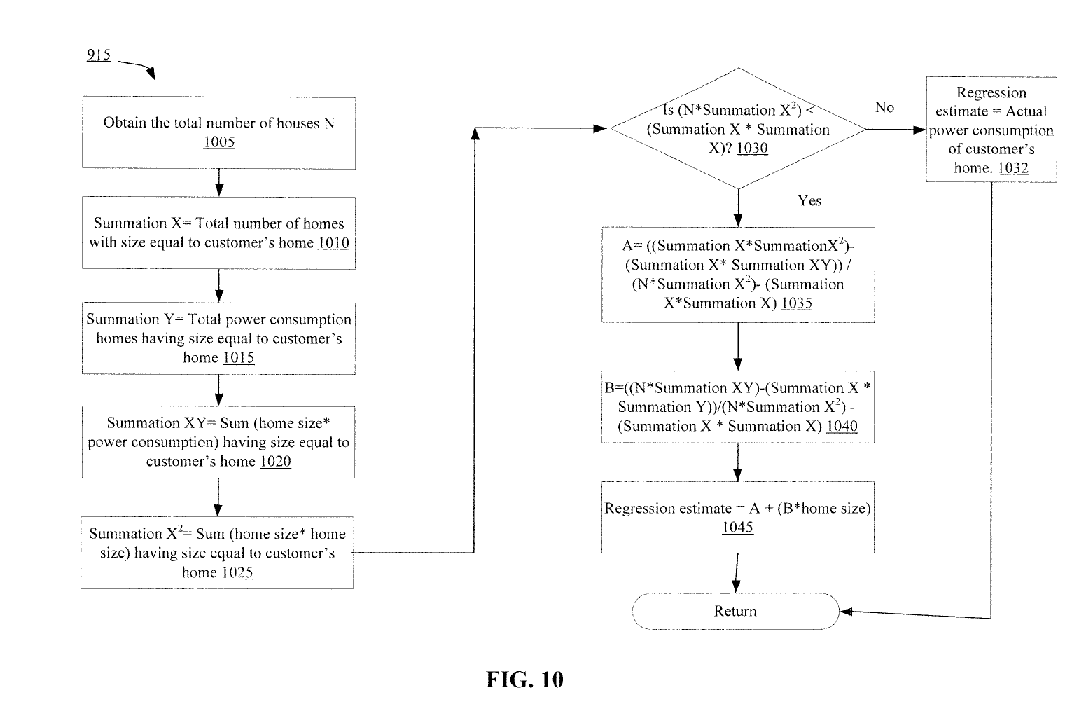

In step 910, the utility management computing device 14 computes the regression estimate of power consumption. In this example, the utility management computing device 14 uses the utility data such as size of the customer's home, total number of houses within the same zip code or city or locale of the customer's home, and demographic data associated with the customer's home to compute the regression estimate of power consumption, although the utility management computing device 14 can use other parameters to compute the regression estimate of power consumption. In addition to the previously listed parameter, the utility management computing device 14 can compute the regression estimate of power consumption for a particular season or for a particular month of a year. This step of computing the regression estimate will now be further illustrated with reference to an example illustrated in FIG. 10.

Referring to FIG. 10, in step 1005 the utility management computing device 14 obtains the number of houses having the same size as the customer's home located within the same zip code of the customer, although the utility management computing device 14 can obtain the total number of houses located within the same zip of the customer's home.

In step 1010, the utility management computing device 14 computes a summation X which includes the total number of houses having size equal to the size of the customer's home located within the same zip code of customer's residence.

Next in step 1015, the utility management computing device 14 computes a summation Y which includes a total power consumption value for all houses having size equal to the customer's home located within the same zip code of customer's residence.

In step 1020, the utility management computing device 14 computes a product of summation X computed in step 1010 and summation Y in step 1015 for all houses having size equal to the customer's home located within the same zip code of customer's residence.

In step 1025, the utility management computing device 14 computes a square of summation X by multiplying the value of summation X with the value of summation X for all houses having size equal to the customer's home located within the same zip code of customer's residence.

In step 1030, the utility management computing device 14 determines if the product of total number of homes having size equal to the customer's home located within the same zip code of the customer's residence and the summation of X square value computed in step 1025 is less than the product of summation of X and summation of X. If the utility management computing device 14 determines that the value is greater, then the No branch is taken to step 1032 where the regression estimate is equal to the actual power consumption of the customer's home. However, if the utility management computing device 14 determines that the value is lesser, then the Yes branch is taken to step 1035.

In step 1035, the utility management computing device 14 computes an arbitrary value A using the formula ((Summation X*SummationX²)−(Summation X*Summation XY))/(N*Summation X²)−(Summation X*Summation X).

Next in step 1040, the utility management computing device 14 computes an arbitrary value B using the formula ((N*Summation XY)−(Summation X*Summation Y))/(N*Summation X²)−(Summation X*Summation X).

In step 1045, the utility management computing device 14 computes the regression estimate for the customer's home using the formula A+(B*home size).

Referring back to FIG. 9, in step 915 the utility management computing device 14 computes a power consumption variance value for the customer's home using the formula consumption variance=abs|Actual consumption−Regression Estimate|/100, although the utility management computing device 14 can compute the power consumption variance value using other techniques.

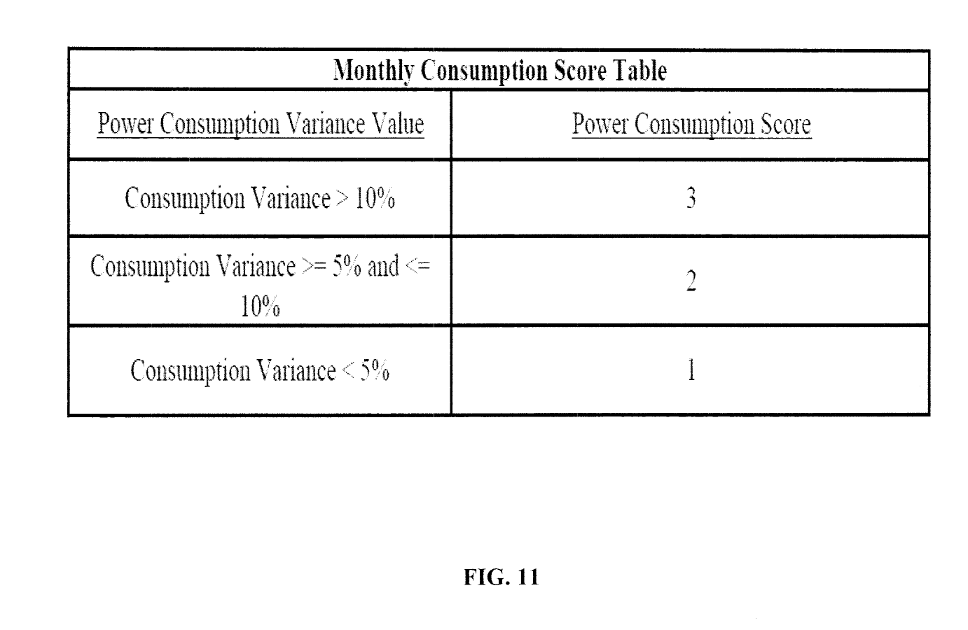

Next in step 920, the utility management computing device 14 computes the power consumption score using the power consumption variance value computed in step 915. By way of example only, the utility management computing device 14 computes a monthly power consumption score, although the utility management computing device 14 can compute a quarterly, half-yearly or yearly power consumption score. In this example, the utility management computing device 14 refers to a table illustrated in FIG. 11 including the range of the power consumption variance and the corresponding power consumption value to determine the monthly power consumption score of the customer, although the utility management computing device 14 can use other techniques to determine the power consumption score.

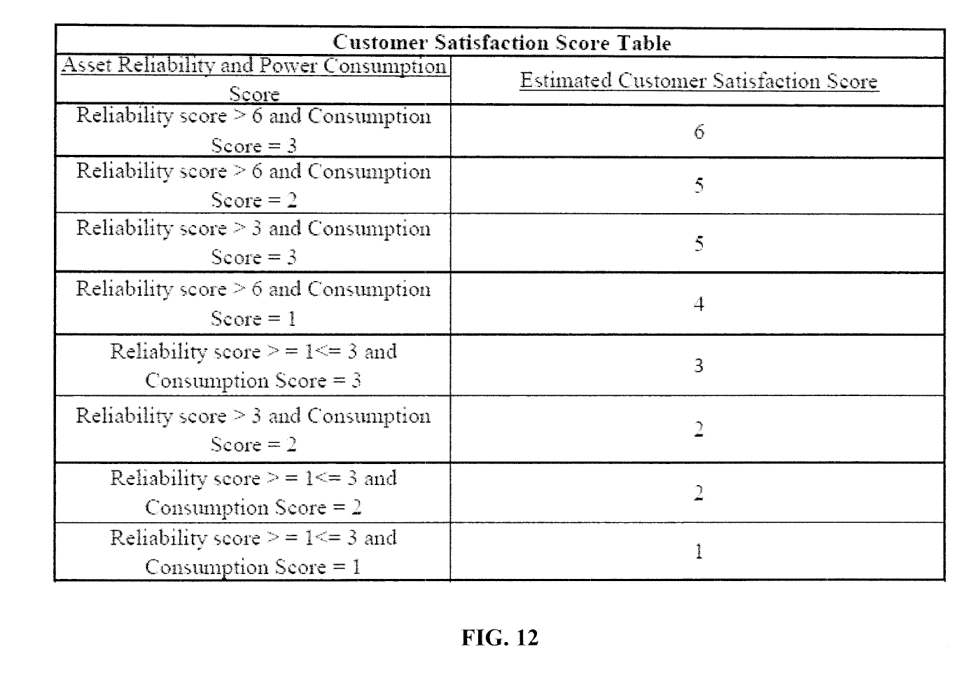

Referring back to FIG. 4, in step 430 the utility management computing device 14 predicts the customer satisfaction score using the asset reliability score computed in step 420 and the power consumption score computed in step 425, although the utility management computing device 14 can predict the customer satisfaction score using other parameters or techniques. In this example, the utility management computing device 14 using a table illustrated in FIG. 12 stored within the memory 20 which includes the combination of the asset reliability score and the power consumption score and the corresponding customer satisfaction score, assesses the customer satisfaction score. By way of example only, the utility management computing device 14 predicts the customer to be very satisfied when the assessed customer satisfaction score 1 and the utility management computing device 14 predicts the customer not being satisfied when the customer satisfaction score 6, although other ranges of scoring could be used. For example, the customer satisfaction score and the satisfaction of the customer could be in reverse order, that is, customer satisfaction score 6 indicating a very satisfied customer and customer satisfaction score 1 indicating the customer not being satisfied and a greater or smaller range could be used.

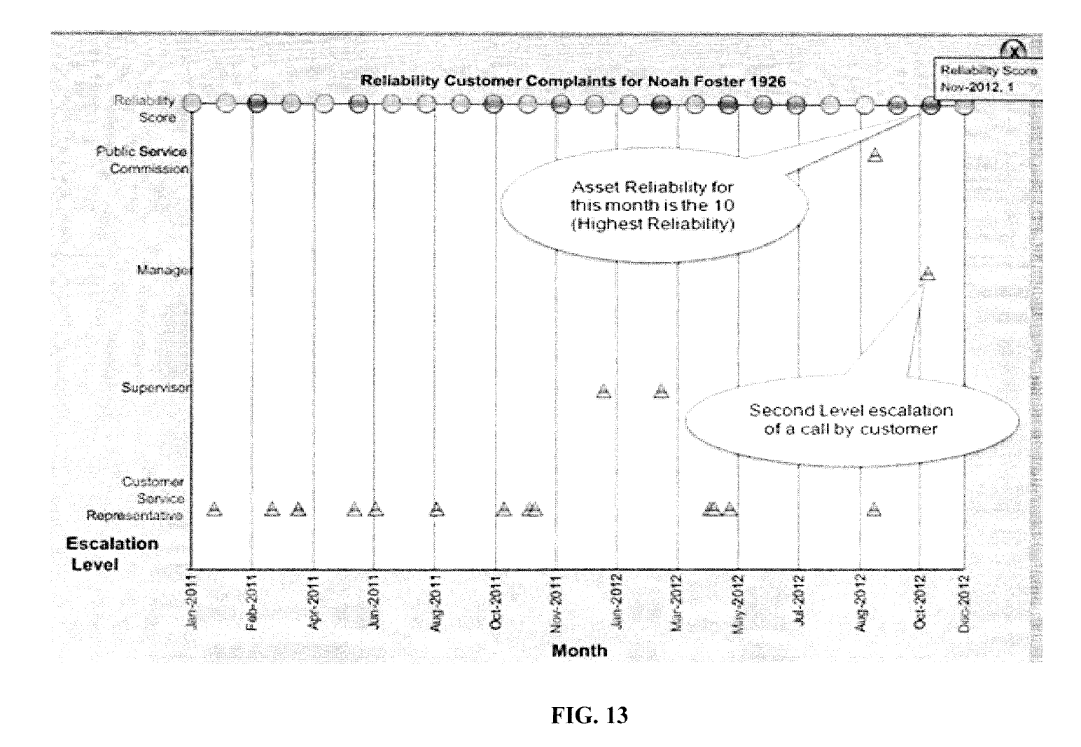

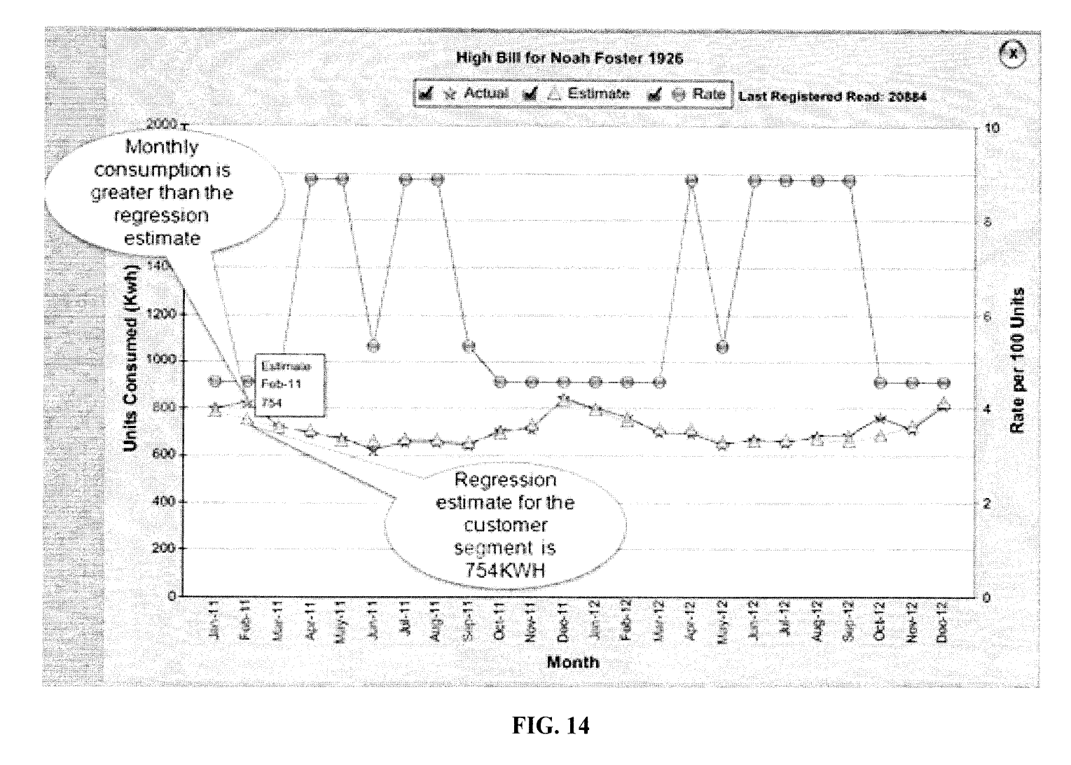

In step 435, the utility management computing device 14 provides a visual representation of the predicted customer satisfaction score along with the other computed details such as asset reliability score and the power consumption score as illustrated in FIGS. 13-14 to the requesting one of the plurality of customer service computing devices 12(1)-12(n), although the utility management computing device 14 can provide other types or amounts of details as a visual representation and the exemplary process ends. Additionally in this example, the utility management computing device 14 provides suggestions to improve the predicted customer satisfaction score using a table which includes customer satisfaction score and the corresponding suggestions, although the utility management computing device 14 can use other techniques to provide the suggestions.

The technology disclosed herein provides advantages of a uniform, linear and an actionable measure of customer satisfaction based on asset reliability score and consumption score, although other types or numbers of scores could be used while measuring the customer satisfaction. Additionally, as the customer satisfaction score is based on multiple sources of inputs, a rounded profile of the customer profile is provided to the customer service representative to take necessary actions. The technique of estimating customer satisfaction also provides adequate granularity thereby providing effective information on the basis for the score.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for predicting customer satisfaction, the method comprising:
obtaining, by a utility management computing device, data associated with one or more electric utilities from an utility monitoring system;
determining, by the utility management computing device, an asset reliability score and a consumption score from the obtained data associated with the one or more electric utilities;
determining, by the utility management computing device, a customer satisfaction score for the one or more electric utilities based on the determined asset reliability score and the consumption score; and
providing, by the utility management computing device, the determined customer satisfaction score for the one or more electric utilities.

2. The method as set forth in claim 1 wherein the determining the asset reliability score further comprises:
identifying, by the utility management computing device,
power outage data from the obtained data associated with one or more electric utilities;
determining, by the utility management computing device, a cumulative frequency of a power outage, a mean frequency of the power outage for each of one or more customers from the identified power outage data;
determining, by the utility management computing device, an average power outage value based on the determined cumulative frequency and the mean frequency;
identifying, by the utility management computing device, a power outage frequency percentile value from the determine average power outage value;
converting, by the utility management computing device, the identified power outage frequency percentile value to a frequency quartile value based on a power outage conversion table; and
determining, by the utility management computing device, the asset reliability score based on the converted frequency quartile value.

3. The method as set forth in claim 1 wherein the determining the consumption score further comprises:
identifying, by the utility management computing device, an actual power consumption value from the obtained data associated with one or more electric utilities for each of the one or more customers;
obtaining, by the utility management computing device, a regression estimated power consumption value for each of the one or more customers;
determining, by the utility management computing device, a consumption variance value based on the identified actual power consumption value and the obtained regression estimated power consumption value; and
correlating, by the utility management computing device, the determined consumption variance value to a consumption table to determine the consumption score.

4. The method as set forth in claim 1 wherein the determining the customer satisfaction score further comprises associating, by the utility management computing device, the determined asset reliability score and the consumption score to a one or more values present in a customer satisfaction table to determine the customer satisfaction score.

5. The method as set forth in claim 1 further comprising generating and providing, by the utility management computing device, a graphical representation of the determined customer satisfaction score.

6. The method as set forth in claim 1 wherein the data associated with the one or more electric utilities further comprises one or more of, a number of power outages within a set period of time, a summation of an entire power outage, billing information associated with power usage, or demographic information associated with usage of power.

7. The method as set forth in claim 1 further comprising recommending, by the utility management computing device, one or more stored customer service suggestions by correlating the determined customer satisfaction score with a customer service suggestion table.

8. A utility management computing device comprising:
one or more processors;
a memory, wherein the memory coupled to the one or more processors which are configured to execute programmed instructions stored in the memory comprising:
obtaining data associated with one or more electric utilities from an utility monitoring system;
determining an asset reliability score and a consumption score from the obtained data associated with the one or more electric utilities;
determining a customer satisfaction score for the one or more electric utilities based on the determined asset reliability score and the consumption score; and
providing the determined customer satisfaction score for the one or more electric utilities.

9. The device as set forth in claim 8 wherein the one or more processors is further configured to execute programmed instructions stored in the memory for the determining the asset reliability score further comprises:
identifying power outage data from the obtained data associated with one or more electric utilities;
determining a cumulative frequency of a power outage, a mean frequency of the power outage for each of one or more customers from the identified power outage data;
determining an average power outage value based on the determined cumulative frequency and the mean frequency;
identifying a power outage frequency percentile value from the determine average power outage value;
converting the identified power outage frequency percentile value to a frequency quartile value based on a power outage conversion table; and
determining the asset reliability score based on the converted frequency quartile value.

10. The device as set forth in claim 8 wherein the one or more processors is further configured to execute programmed instructions stored in the memory for the determining the consumption score further comprises:
identifying an actual power consumption value from the obtained data associated with one or more electric utilities for each of the one or more customers;
obtaining a regression estimated power consumption value for each of the one or more customers;
determining a consumption variance value based on the identified actual power consumption value and the obtained regression estimated power consumption value; and
correlating the determined consumption variance value to a consumption table to determine the consumption score.

11. The device as set forth in claim 8 wherein the one or more processors is further configured to execute programmed instructions stored in the memory for the determining the customer satisfaction score further comprises associating the determined asset reliability score and the consumption score to a one or more values present in a customer satisfaction table to determine the customer satisfaction score.

12. The device as set forth in claim 8 wherein the one or more processors is further configured to execute programmed instructions stored in the memory further comprising generating and providing a graphical representation of the determined customer satisfaction score.

13. The device as set forth in claim 8 wherein the data associated with the one or more electric utilities further comprises one or more of, a number of power outages within a set period of time, a summation of an entire power outage, billing information associated with power usage, or demographic information associated with usage of power.

14. The device as set forth in claim 8 wherein the one or more processors is further configured to execute programmed instructions stored in the memory further comprising recommending one or more stored customer service suggestions by correlating the determined customer satisfaction score with a customer service suggestion table.

15. A non-transitory computer readable medium having stored thereon instructions for predicting customer satisfaction comprising machine executable code which when executed by at least one processor, causes the processor to perform steps comprising:
obtaining data associated with one or more electric utilities from an utility monitoring system;
determining an asset reliability score and a consumption score from the obtained data associated with the one or more electric utilities;
determining a customer satisfaction score for the one or more electric utilities based on the determined asset reliability score and the consumption score; and
providing the determined customer satisfaction score for the one or more electric utilities.

16. The medium as set forth in claim 15 wherein the determining the asset reliability score further comprises:
identifying power outage data from the obtained data associated with one or more electric utilities;
determining a cumulative frequency of a power outage, a mean frequency of the power outage for each of one or more customers from the identified power outage data;
determining an average power outage value based on the determined cumulative frequency and the mean frequency;
identifying a power outage frequency percentile value from the determine average power outage value;
converting the identified power outage frequency percentile value to a frequency quartile value based on a power outage conversion table; and
determining the asset reliability score based on the converted frequency quartile value.

17. The medium as set forth in claim 15 wherein the determining the consumption score further comprises:
identifying an actual power consumption value from the obtained data associated with one or more electric utilities for each of the one or more customers;
obtaining a regression estimated power consumption value for each of the one or more customers;
determining a consumption variance value based on the identified actual power consumption value and the obtained regression estimated power consumption value; and
correlating the determined consumption variance value to a consumption table to determine the consumption score.

18. The medium as set forth in claim 15 wherein the determining the customer satisfaction score further comprises associating the determined asset reliability score and the consumption score to a one or more values present in a customer satisfaction table to determine the customer satisfaction score.

19. The medium as set forth in claim 15 further comprising generating and providing a graphical representation of the determined customer satisfaction score.

20. The medium as set forth in claim 15 wherein the data associated with the one or more electric utilities further comprises one or more of, a number of power outages within a set period of time, a summation of an entire power outage, billing information associated with power usage, or demographic information associated with usage of power.

21. The medium as set forth in claim 15 further comprising recommending one or more stored customer service suggestions by correlating the determined customer satisfaction score with a customer service suggestion table.
